(19) United States
(12) Patent Application Publication
(10) Pub. No.: US 2009/0301852 A1
(43) Pub. Date: Dec. 10, 2009

(54) Integrated Switch or Integrated Button

(75) Inventors: Christoph Keist, Wattwil (CH); Klaus Hoffmann, Grenzach-Wyhlen (DE)

Correspondence Address: THE WEBB LAW FIRM, P.C., 700 KOPPERS BUILDING, 436 SEVENTH AVENUE, PITTSBURGH, PA, 15219, US

(73) Assignee: ABATEK INTERNATIONAL AG, Bassersdorf (CH)

(21) Appl. No.: 12/093,072

(22) PCT Filed: Oct. 25, 2006
(86) PCT No.: PCT/CH06/00596

§ 371 Date: Mar. 18, 2009

(30) Foreign Application Priority Data
Nov. 9, 2005 (CH) 1793/05

(51) Int. Cl. H01H 13/14

(52) U.S. Cl. 200/341

(57) ABSTRACT

A switch, especially for use in the interior of a vehicle, which is to be embedded at least in part in or on a support that is covered, at least in the area of the switch, with a preferably flexible surface material on the surface thereof. The switch is disposed in an opening of the surface material while including a first zone located substantially in the support and a second push button used for triggering a function. The push button is embodied so as to cover at least some areas of the opening in the surface material and be non-positively and/or positively connected thereto. Also disclosed are a method for assembling such a switch as well as uses thereof as a window control and similar.

### TECHNICAL FIELD

The present invention relates to an integrated switch or an integrated button for component parts which are provided with a preferably flexible surface covering.

### PRIOR ART

In particular in the automotive sector the trend nowadays is heading ever more in the direction of buttons and switches being integrated directly in the interior and therefore being as unobtrusive as possible. Most interior surfaces in an automobile are, in addition to plastic, so-called natural materials such as leather or textile, i.e. supports or housings providing the structure in the case of these surfaces are provided with a surface covering made from a soft and/or flexible material.

It is easily possible to position a button behind a leather or textile surface and therefore to integrate the switching function directly in the surface. Symbols can be, for example, printed on or adhesively bonded on in such situations.

What is nowadays lacking are buttons which are integrated, for example, directly in the surface with backlit symbols which are also visible at night and buttons which can be installed without a considerable amount of complexity in terms of fitting and which protrude slightly beyond the surface covering.

### DESCRIPTION OF THE INVENTION

Accordingly, the invention is based inter alia on the object of providing an improved switch or an improved momentary-contact element which, among other things, makes backlighting possible. Furthermore, a method is provided with which such a switch can be installed in a cost-effective and resistant manner. What is involved here are switches which perform simple on/off functions, but equally also switches which can perform more complex functions such as those of rockers, navigators in different directions, etc.

The term switch in the context of the present invention is therefore to be understood as meaning a momentary-contact element, which can be triggered by a finger, for example, and which can pass on the pulses desired by the operator to a controller, for example, via a contact mechanism and/or circuit positioned behind it. In this case, it is a question of a switch for at least partially embedding in or on a support, which is coated, at least in the region of the switch, on its surface with a preferably flexible surface material. The support may be a housing part or else a seat cushion or a steering wheel, a shift lever or the like, for example. The flexible surface material, which is provided as the surface covering, can be textile, leather, imitation leather, a plastic layer or a metal layer or combinations thereof.

This is achieved, inter alia, by virtue of the fact that the switch is arranged in a cutout of the surface material, the switch having a first region arranged substantially in (or possibly also on) the support and a second button head provided for manually triggering a function. In this case, the button head covers the cutout in the surface material, at least in regions, on the upper side of the surface material and is connected thereto in a force-fitting and/or form-fitting manner. The term “so as to cover the cutout” is in this case understood to mean that the button head has a contour which is greater than the size of the cutout and therefore the button head with its underside covers the surface of the surface material in the edge region, at least in regions, preferably peripherally.

In accordance with the prior art, such switches are provided with a housing part, in which the actual button head is recessed. In other words, the button head is recessed in a housing which is likewise exposed at least in the edge region toward the surface. This housing part in this case needs to be embedded correspondingly with this edge, which is exposed toward the surface and frames the actual button, in a cutout in the surface material with a very precise fit.

One of the essential aspects of the invention therefore consists in now entirely dispensing with such an exposed edge of a housing and the button head, which is preferably manufactured from a flexible material such as silicone, for example, or a flexible plastic (even thin leather is possible) being adhesively bonded directly to the surface material at the edge, for example. Such a switch correspondingly requires a formation of a cutout in the surface covering which has a substantially less precise fit and can have a more compact design and can be integrated substantially more easily.

In accordance with a first preferred embodiment of the switch, the button head covers the cutout in the surface covering peripherally. Further preferably, it is correspondingly adhesively bonded to the surface material peripherally. In this case, adhesive films, silicone, adhesives or other suitable adhesives can be used.

In accordance with another preferred embodiment, the switch is characterized by the fact that the button head has at least one fastening element, by means of which the button head is fastened in the surface region, which is covered by the underside of the button head, of the surface material to said surface material. In this case, the fastening element can preferably be in the form of a lug (or flexible pin), which makes a form-fitting connection possible by means of being bent back. In other words, in accordance with a preferred embodiment it is possible for the fastening element to be a lug, which engages in an opening in the surface material and wherein either self-latching (for example resilient tongues or else projections which, as a result of the extension of the soft surface material during insertion through the opening, bring about fixed hooking once the material has passed through completely) or by fastening by means of adhesive bonding and/or bending back is possible. The latter, i.e. fastening by means of being bent back, is preferred, in this case the bending-back taking place on the underside of the surface material and, as a result, fastening taking place in a form-fitting and/or force-fitting manner (if, for example, an adhesive is additionally used).

It is preferred if the fastening element is fastened in a form-fitting manner in or on the button head.

A further preferred embodiment is characterized by the fact that a metal frame (peripherally or else partially interrupted) is arranged in or on the button head, at least one fastening element, which, for example, protrudes out of the button head, being fastened and/or integrally formed on said metal frame. The metal frame is preferably arranged in or on the button head so as to be peripheral at least in regions and has a plurality of fastening elements in the form of lugs.

In accordance with a further preferred embodiment, the fastening element and one or more possibly provided metal frames are made from a flexible and/or electrically conductive material, in particular preferably from a metal. The fastening element and the metal frame (or at least segments of the metal frame) are preferably designed to be integral and in particular preferably to be produced in a stamping deformation process.

Such fastening elements and metal frames which may be provided have proven to be particularly useful for making at least indirect contact with a lighting element, which is arranged in the button head. In this case, at least two fastening elements and one metal frame made from an electrically conductive material, in particular preferably from a metal, can be arranged, and the metal frame can comprise two electrically isolated segments, each segment having a fastening element, and in particular preferably the lighting element (for example an LED) is connected with its two electrical terminals to these segments via webs or wires. Very simple production is therefore made possible. That is to say that, for example, the metal frame can be produced together with the fastening elements in a stamping deformation process, and then the lighting element can be fitted thereon (for example by means of soldering). This component part is then inserted into the mold for producing the button head and embedded in the compound of the button head in the production process.

Preferably, the at least one fastening element is in the form of a lug, which lugs pass through openings in the surface material and in addition through openings in further elements, which are arranged therebeneath, for example through openings in a printed circuit board and/or the support and/or in a fastening component part. The lug is then bent back on the side which faces away from the surface material of the entirety of the elements through which it passes.

A further preferred embodiment is characterized by the fact that the switch has a sensor function and a switch function, in this case in particular preferably a printed circuit board, for example in the form of a flexible printed circuit board, being arranged, which printed circuit board, on one side, preferably the upper side, provides the functionality for the sensor function and, on the other side, preferably the underside, provides the switch function, with a further tactile element preferably being arranged on the underside for this purpose.

Another preferred embodiment is characterized by the fact that a large number of tactile elements is arranged beneath the button head, it being possible for these tactile elements to be arranged in a row and/or in a circle and/or a semicircle or in a combination thereof.

A further preferred embodiment of the switch is characterized by the fact that the first region has at least one tactile element, which produces a contact, for example a control pulse in a printed circuit board arranged in the first region (a flex circuit or sensor etc. are also possible, for example), with tactile feedback, on manipulation of the button head.

As already mentioned, such a switch can preferably be provided with backlighting. This is preferably easily possible when the button head is designed to be transparent or at least partially translucent. Depending on the arrangement of the light source, it may prove to be advantageous to produce tactile elements arranged in the first region from a substantially transparent or at least partially translucent material as well, for example when the light source is arranged in the first region behind the tactile elements. It is possible to design regions on or in the button head to be impervious to light so as to form backlit symbols, for example by a light-impervious coating being provided on (or beneath) the button head, which coating has reliefs in the form of symbols or characters.

In accordance with a further preferred embodiment, the support may be a component part in the interior of a vehicle, in particular inner cladding, a steering wheel, a gearshift, a car seat or the like.

As already mentioned, the button head is preferably a flexible element, which protrudes beyond the surface of the surface covering at least in the edge region, in which the surface covering is covered. The button head can have, for example, a convex surface, which, in rounded-off form, protrudes beyond the surface of the flexible surface material and merges with the surface material, for example forming a sharp edge or else with a sliding edge.

As already mentioned, the cutout in the surface material is smaller than the surface cross section of the button head, with the result that the button head covers the surface material peripherally in the edge region. In this case, the coverage is preferably overall at least in the range of from 0.5-10 mm, in particular preferably in the range of 2-3 mm. The first region is preferably also arranged at least in regions in the edge region behind the cutout, i.e. it is preferably covered peripherally by the cutout in the surface material.

Another preferred embodiment of the switch according to the invention is characterized by the fact that a recess, for example with a depth in the range, of 1-20 mm, preferably of 3-8 mm, is provided in the support. A printed circuit board, a flex circuit or a sensor is provided as a component part of the switch on the bottom of this recess, and these elements can be adhesively bonded on the bottom of the recess, for example with the aid of an adhesive or an adhesive film. A preferably transparent base element, which can likewise be adhesively bonded, is provided on these elements. This base element preferably has a shape which is matched to the shape of the recess and can comprise, for example, transparent silicone. The base element has either tactile elements as separate component parts or such tactile elements are formed as a component part of the base element, i.e. are designed to be integral with it. Examples of tactile elements are switchpads, metal domes (for example metal dome foil) or polydomes (polydome film), silicone domes. A button head is then arranged on this base element or on the tactile elements and adhesively bonded thereto, preferably the surface material being clamped in between the base element and the button head and/or being adhesively bonded thereto.

As already mentioned, the switch may also be a complex configuration, for example a switch which has at least two different positions or control contacts, which can be manipulated via a single button head. Preferably, the switch has only one single button head.

Furthermore, the present invention relates to inventive uses of such a switch, for example as an individual button, rocker, navigator in different directions (cf. joystick) or two-stage or multistage switch. Preferably, such a switch is used in the interior of a vehicle, for example as a window opener, mirror adjuster, seat adjuster or switch which is integrated in clad instrument panels for car radio/air conditioning/navigation/telephone etc.

Furthermore, the present invention relates to a method for fitting such a switch. In this case, in a first step a support, for example a vehicle seat, is coated with a flexible surface material substantially over the entire area in accordance with the conventional process in this field. In this case it is not important whether the surface material is adhesively bonded to the support over the entire area. In a second step the surface material is cut out or stamped out to the desired size so as to form a cutout, for example in the region of recesses which are preferably provided in the support. In a third step, the switch is then inserted into the recess (with the surface material possibly being temporarily extended in the region of the cutout) and then the flexible button head is adhesively bonded peripherally onto the surface of the surface material in the edge region of the cutout. In this case it is possible to first of all produce the switch in two parts, a first region and the button head. In this case, in the third step first the first region can be inserted through the cutout into the recess and fixed therein, and then the button head can be positioned onto the first region and onto the surface material and fixed thereto, for example adhesively bonded thereto.

Further preferred embodiments of the switch, the uses and the method for fitting are described in the dependent claims.

### BRIEF EXPLANATION OF THE FIGURES

The invention will be explained in more detail below with reference to exemplary embodiments in connection with the drawings, in which:

FIG. 1 shows a schematic section through a switch which is integrated in a support in accordance with the invention;

FIG. 2 shows possible steps for fitting a switch, as illustrated in FIG. 1;

FIG. 3 shows a schematic section through a switch integrated in a support in accordance with the invention according to a further exemplary embodiment;

FIG. 4 shows a schematic section through a switch integrated in a support in accordance with another exemplary embodiment;

FIG. 5 shows in a), a schematic section through a switch integrated in a support in accordance with a further exemplary embodiment, in which the fastening of the button head on the soft surface material takes place by means of fastening lugs on a metal frame inserted in the button head; in b), a button head with a metal frame fastened thereon or therein with fastening lugs, which are not yet bent back; and in c), an integral metal frame with fastening lugs;

FIG. 6 shows in a), a schematic section through a switch integrated in a support in the form of a short-stroke button with an LED in the button head in accordance with a further exemplary embodiment, and in b), a metal frame with an integrated LED and with fastening lugs;

FIG. 7 shows a schematic section through a switch integrated in a support in the form of a short-stroke button with an LED on a flex PCB in accordance with a further exemplary embodiment;

FIG. 8 shows a schematic section through a switch integrated in a support in the form of a long-stroke button with an LED on a double-sided printed circuit board with a touch sensor in accordance with a further exemplary embodiment; and

FIG. 9 shows a schematic section through a switch integrated in a support in the form of a rotary knob or an incremented controller in accordance with a further exemplary embodiment.

### DETAILED DESCRIPTION OF THE INVENTION AND EMBODIMENTS

Backlit keyboards can be produced using transparent silicone or plastic; this is nowadays already in wide use, for example in combination with a plastic housing. The idea is now to integrate individual backlit silicone buttons directly in a leather, plastic, metal or textile surface. In this case, the button head is fastened on the surface material by means of an adhesive layer, with the result that a tight and fixed connection is provided. The unclean cut edge of the surface material is covered by the button cap. Therebeneath there is then a base element, which is fastened on the underside of the surface material. A tactile element beneath the button cap takes over the switching function and produces the tactile feedback to the operator indicating that the contact is closed. A contact pill closes the electrical contact, for example on the printed circuit board. By means of a light source, the symbols on the button head are backlit through the transparent tactile element and the transparent button head.

The parts are all connected to one another and, as an entire unit, integrated in a support housing or seat cushion.

For illustrative purposes, a few exemplary embodiments of such a switch or such a keyboard will be presented below with the aid of the figures. It should be emphasized here that the exemplary embodiments are only used for illustrative purposes and not for restricting the scope of protection as defined in the patent claims.

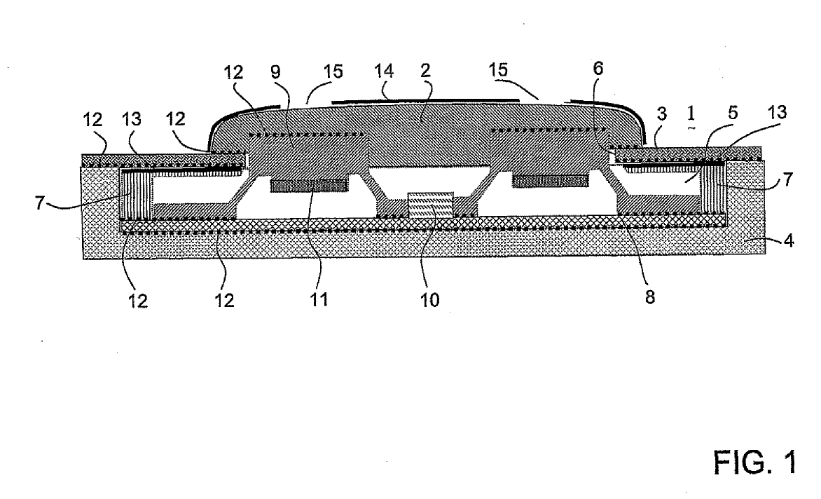

FIG. 1 shows a schematic section through a switch 1 which has been recessed in a support 4. The support housing 4, in which the unit is integrated, can be, for example, a vehicle seat, an instrument panel, a vehicle door, for example cladding of a vehicle door etc. A recess 5 or depression is provided in the support housing 4, in which recess 5 or depression the actual switch 1 or the button/keyboard is recessed. This recess typically has a depth in the range of 1-10 mm, and it advantageously has rear access points for terminals of the switch 1.

The support housing 4 is coated with a layer of a surface material 3. This surface material 3 can be textile, leather, slush or another surface material which covers the component part. The surface material 3 is typically flexible and can have a coating or a three-dimensional structuring on the surface. In the region of the recess 5, a cutout 6 is provided in the surface material, through which cutout the switch 1 passes.

The actual switch 1 comprises a first region, which is arranged predominantly beneath the surface material 3, i.e. on or in the support structure 4. First, a printed circuit board 8 or a flex circuit or a sensor (only referred to as printed circuit board 8 below) is arranged on the bottom of the recess 5. This printed circuit board 8 is connected to a circuit via lines routed in the region of the recess and out of it or is connected directly to the member to be actuated (for example motor for window opener). Conductor tracks (not illustrated), which trigger the actual functionality in the event of actuation of the switch (closing or opening of a control circuit), are provided on the printed circuit board 8.

On the one hand, a base element 7, which is made from transparent silicone, for example, is arranged on this printed circuit board 8. On the other hand, one or more tactile elements 9 are arranged in the central region.

Possible tactile elements used are switching mats, metal domes, polydomes etc. Preferable here are component parts made from at least partially transparent material. This may also be, as illustrated in FIG. 1, for example, one or more silicone domes each having a contact element 11, for example a pill with a coating or made from conductive material, on the underside facing the printed circuit board 8. When the tactile element 9 is actuated, it is deformed downwards so as to provide tactile feedback and the contact element 11 is pressed onto conductor tracks arranged therebeneath on the printed circuit board 8, with the result that a contact is closed. If, as an alternative, a metal dome is used as the tactile element 9, the metal dome itself acts as the contact-making element and a contact pill is not necessary.

The tactile element 9, in precisely the same way as the base element 7, is transparent or at least partially translucent. In addition, a light source 10 for example in the form of an LED is arranged beneath or between the tactile elements 9. The use of an electroluminescent film (see further below) is also possible. The light emitted by this light source 10 can pass through the transparent elements of the first region and therefore to the surface.

Furthermore, the switch 1 comprises a button head 2. This button head 2 is made from a transparent or slightly colored, light-pervious material (plastic, elastomer or silicone). In its edge region, the button head 2 engages over the cutout 6 in the soft surface material 3. The button head 2 is provided, in addition, with a preferably wear-resistant colored layer 14 (single-layered or multilayered) either on its surface, as illustrated in FIG. 1, or on its underside. Symbols are formed as a relief in this layer 14, which symbols can be identified both with frontlighting (without backlighting) and in the dark in the case of backlighting by means of the light source 10. The symbols 15, which may be pictograms, symbols or alphanumeric characters, can be produced, for example, by means of lasers.

In order to fasten the switch in the recess 5, the printed circuit board 8 is preferably fixedly bonded on the bottom of the recess 5. The corresponding layers of adhesive 12 are each illustrated by dots in FIG. 1. The adhesive layer 12 is matched to the respective substrates and may also be double-sided adhesive strips or adhesive films. Possible adhesives, depending on the substrates, are, for example, RTV silicone adhesive, hot-melt adhesive etc.

The base element 7 and the tactile elements 9 are also $ fastened on the printed circuit board 8 using an adhesive layer 12 or an adhesive film. In addition, the base element 7 first can have a light-impervious layer 13 (for example black sprayed-on layer) on the upper side facing the soft surface material 3 in order to ensure that light from the light source 10 does not pass through the surface material 3 in the region thereof which directly adjoins the button head. In addition, the base element 7 can also be adhesively bonded to the underside of the surface material 3. The button head 2 is also adhesively bonded to the first region of the switch 1, i.e. to the tactile elements 9 in the example shown in FIG. 1.

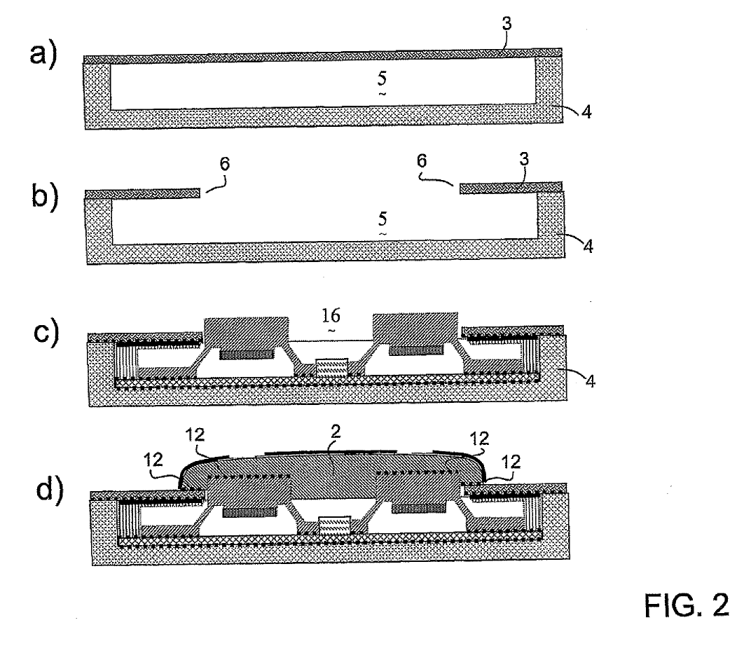

In principle it is possible to provide the entire switch 1 in the already completely assembled form and to install it into a recess 5 as a whole. However, it is also possible, as is illustrated in the following FIG. 2, for the switch 1 to be assembled completely only once it has been installed in the recess. For this purpose, the button head 2 is first of all not adhesively bonded to the first region but is bonded to the first region and the surface material only entirely at the end once it has been installed into the recess 5.

FIG. 2 shows a possible process for installing a switch 1 in a support covered by a soft surface material 3. For this purpose, as is illustrated in FIG. 2a), a support 4 is provided with a covering of surface material 3 in a conventional process. In this case, the recesses or depressions already provided for the switch 1 are simply covered, which makes it possible to use a standard process for providing the covering of surface material.

Once the component part has been provided with the covering of the surface material 3 and possibly further working steps have been carried out, a cutout 6 is formed for the installation of the switch at the suitable point, i.e. above the recess 5 but with a smaller cross section than the recess 5. This is illustrated in FIG. 2b). This cutting-out process can take place via a cutting process (laser cutting is also possible), a stamping process or another suitable process.

A switch, onto which the button head 2 has not yet been positioned, is now inserted into the thus prepared cavity, as is illustrated in FIG. 2c). The printed circuit board 8 is in this case adhesively bonded to the bottom of the recess 5, and possibly the wiring and/or terminals required for connecting the printed circuit board to a controller are provided. In addition it is possible to adhesively bond the underside of the surface material 3 to the support 4 in the region adjoining the recess 5 and equally to the upper side of the base element 7.

Now only the button head 2 can be positioned from above, as is illustrated in FIG. 2d). On the one hand, the button head 2 is in this case adhesively bonded to the first region, in particular to the upper side of the tactile elements 9, and on the other hand the button head 2 is adhesively bonded peripherally to the surface material 3 in the region covering the soft surface material.

In this context, it should be emphasized that it is on the one hand possible to manufacture the button head 2 from a rigid material and to a certain extent to ensure the movability by means of the base element 7 and the likewise flexible surface material 3 positioned above this. Preferably, however, the button head 2 is also produced from a soft material such as silicone, for example.

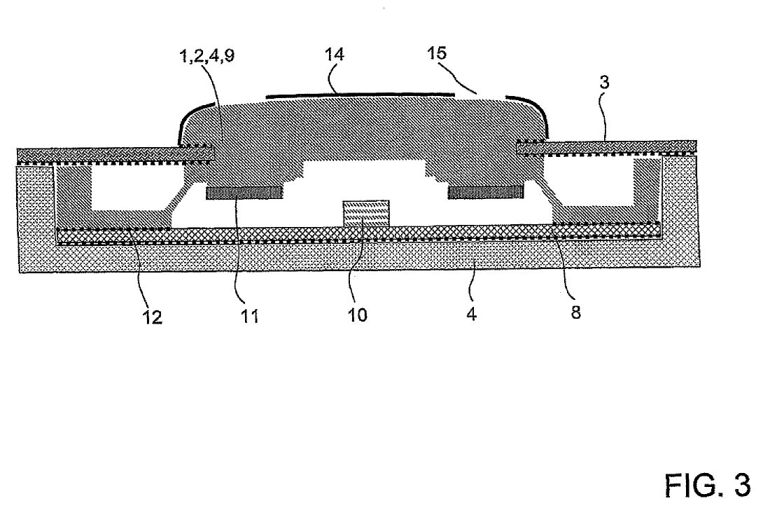

FIG. 3 illustrates an alternative exemplary embodiment. In this case, the button head 2, the base element 7 and the tactile element(s) 9 are manufactured as an integral component part, for example from silicone.

In order to make embedding into the surface material 3 in accordance with the invention possible, this component part has an undercut, into which the surface material 3 is introduced and bonded.

This construction is advantageous in terms of manufacturing technology to the extent that in a single step the element comprising the button head, the base element and the tactile elements can be produced and only the contact elements 11 then need to be adhesively bonded and the printed circuit board positioned in order to produce the switch. On the other hand, this construction does not allow for installation as illustrated in FIG. 2, i.e. the button head cannot be positioned at the end. This disadvantage can be overcome, however, for example by the edge region with the undercut being structured in such a way that this edge region can be turned upwards for fitting purposes, with the result that the surface material can be inserted and adhesively bonded easily peripherally in the edge region.

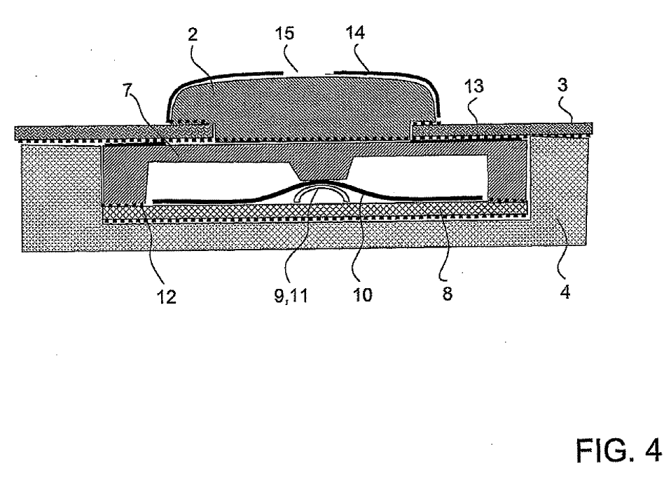

A further alternative exemplary embodiment is illustrated in FIG. 4. In this case, the tactile element 9 is formed by a metal dome 11, and a flexible electroluminescent film 10 is provided as the light source. In the exemplary embodiment shown in FIG. 4, the base element 7 is in the form of a component part which is separate from the button head 2, but it is naturally also possible for the base element 7 to be designed to be integral with the button head 2. The base element 7 advantageously has a downwardly pointing rib or a downwardly pointing tab (plunger) in the region facing the metal dome in order to ensure effective support and to ensure tactile feedback given the correct depression depth of the switch.

The following variants of the abovedescribed exemplary embodiments are possible and each have specific advantages:

Button Head 2:

Individual button, rocker, navigator in different directions, two-stage switch etc.

Any desired shape: round, circular, oval, angular, polygonal etc.

An individual button or a plurality of buttons next to one another or one above the other, in each case one tactile element or a plurality of tactile elements per button.

Material Used: Plastic, Metal or Silicone.

Connection of button head: bonding to tactile element 9 or to combined part comprising tactile element 9, possibly base element 7, with button head with undercut.

Tactile Element 9:

Silicone switching mat with contact pill, metal dome, polydome or silicone switching mat with plunger on pressure sensor.

Light Source 10:

LED or electroluminescent film (rigid or flexible).

Printed Circuit Board 8:

Standard printed circuit board or flexible printed circuit board (flex circuit) or pressure sensor film.

Surface Material 3:

Leather, textiles, slush, silicone or other flexible materials. Thickness preferably <1 mm, i.e., for example, in the range of 0.01-2 mm, preferably in the range of 0.3-1 mm.

Adhesive Layers 12:

RTV silicone, hot-melt adhesive, adhesive films or direct vulcanization of the surface material 3 in the compression molding die with base element and/or button head.

Light-Impervious Layer 13:

Sprayed onto base element with silicone color or in the form of a film.

Symbols 15:

As night design (lasered), positively or negatively printed.

In general, the following advantages result, inter alia, from the proposed construction:
buttons integrated directly in interior surfaces
symbols are backlit
very high flexibility and quality of the symbols thanks to proven laser process, also complex symbols possible without any problems
force/travel response as in conventional buttons in plastic housings
cost saving since no actual plastic accommodating means is required
space-saving.

The following exemplary applications are possible:
button heads for window openers and mirror adjusters integrated in clad car doors
button knobs for seat adjusters integrated in car seats
button knobs for car radio/air conditioning/navigation/telephone integrated in clad instrument panels.

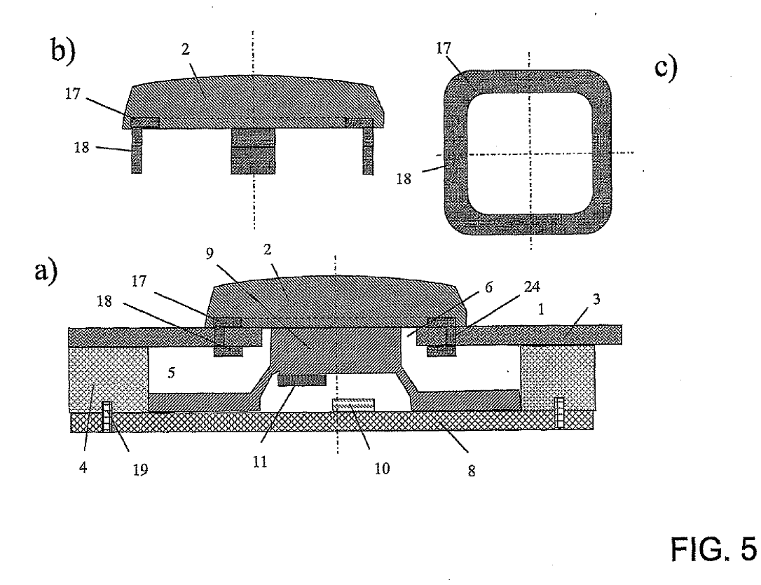

FIG. 5 illustrates a further exemplary embodiment, in which the fastening of the button head 2 on the soft surface material 3 takes place by means of fastening lugs 18 on a metal frame 17 inserted in the button head. In this case, FIG. 5a) illustrates a schematic section through such a switch. FIG. 5b) shows a schematic illustration of a button head 2 with a fastening element fixed thereon in the form of a metal frame 17 and fastening lugs 18 integrally formed thereon, and FIG. 5 shows a plan view of such a metal frame 17 with fastening lugs 18 integrally formed thereon prior to the fastening or integration in a button head 2.

In other words, fastening lugs is, which are provided for fastening purposes preferably in holes or slots 24 in the soft surface material 3, are fitted on the button head 2. In this case, they are pushed through these holes or slots 24 for fastening purposes and then bent back at the free end. The fastening lugs 18 are preferably made from a flexible material, in particular preferably from metal. However, they may also be in principle rigid elements, which have, for example, movable (snap-action tabs) or equally rigid retaining tabs (laterally and/or on the front side or the rear side), in the latter case the fastening lugs 18 being inserted into the slots 24 during fitting with a slight reversible extension of said slots 24.

Preferably, in a so-called co-molding process, an appropriately shaped stamped bent part made from metal (which is preferably produced integrally in a stamping and deformation process from a piece of sheet metal, cf. FIG. 5c)) is inserted into the die for the button head and is then connected directly to the button head material (silicone) in a form-fitting manner or is embedded therein. This takes place, for example, by a component part being provided comprising a peripheral metal frame 17, which to a certain extent is arranged in a plane parallel to the underside of the button head 2, and on which metal frame 17 a plurality of fastening lugs 18 are integrally formed (for example at least one on each side, as illustrated in FIG. 5c), but it is also conceivable to provide the fastening lugs in the corners or to arrange a plurality of fastening lugs per side), which are first arranged in the stamping deformation process substantially perpendicular to the plane of the metal frame 17 and point downwards. Such a component part is then substantially completely embedded in the compound of the button head 2 in the region of the metal frame, and the fastening lugs 18 protrude downwards before the button head is fitted in the soft surface material 3, as is illustrated in FIG. 5b). Thus, the metal frame 17 is completely embedded in the button head 2 in a form-fitting manner. The adhesion can be reinforced by means of bonding agents.

The lugs can also be fitted as individual lugs in a subsequent adhesive-bonding process to the button head or bonded into blind holes in the button head.

The button head 2 is then inserted into the appropriately sized recess 6 in the base material and the fastening lugs 18 are inserted into holes or slots 24, which are likewise provided in the surface material 3, from above at the same time. Then, the fastening lugs 18 are bent back on the underside of the surface material in such a way that the button head 2 is fastened in or on the surface material 3 in a form-fitting manner. The bent edges can in this case already be impressed or stamped in advance on the metal frame.

Then, the tactile element and the printed circuit board are fastened to the support 4 for example by means of screws 19, rivets or by means of adhesive bonding.

Advantages:
simple fitting of the button head without bonding;
as a result of the peripheral metal frame, the button head is rigid and can also not be lifted up between the lugs.

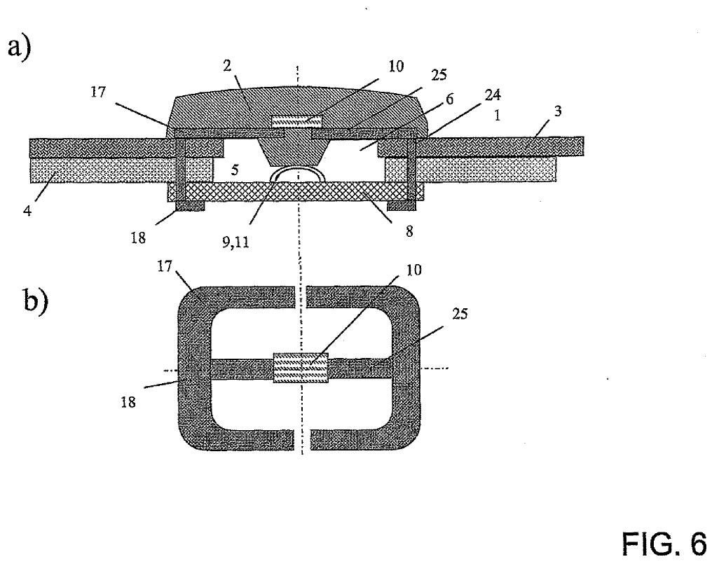

FIG. 6 illustrates a further exemplary embodiment, which is in the form of a short-stroke button with an LED in the button head.

The metal frame 17 with the fastening lugs 18 is plugged through the appropriately shaped cutout 6 in the surface material 3, and the fastening lugs are plugged through the slots 24 and through corresponding recesses in the support 4 and the printed circuit board 8 and are fastened by means of being bent back on the underside of the printed circuit board 8.

This has the enormous advantage that fitting is very simple.

Prior to the co-molding with the button head, a light source (LED) can be soldered to the metal frame, for example in an SMT (surface mount technology) process or by means of wire-bonding. The metal frame in this case needs to be interrupted between the LED terminals in order that contact can be made with the light source via the fastening lugs 18 (which is particularly simple), with the result that there is no short circuit. A corresponding component part prior to it being embedded in a button head 2 is illustrated in FIG. 6b). The component part has two symmetrical stamped bent parts arranged on the left and right, in each case with a lug 18, the metal frame 17 additionally having contact webs 25 for the centrally arranged light source.

The button head 2 with the integrated light source 10 is then plugged on again and connected to the printed circuit board via the fastening lugs 18. In order to obtain good electrical contact, the fastening lugs 18 are best soldered on the printed circuit board 8 once they have been bent back. The fastening lugs 18 in this case therefore not only serve the purpose of fastening the button head 2, but at the same time also act as contact tracks and terminals for the light source 10. The material for the metal frame 17, or at least of the webs 25, must be flexible in order to be able to go along with the short stroke of the tactile element 9, 11 (in this case in the form of a metal dome 11) in the region of the light source 10. The stroke of the button is in this variant essentially only achieved via the deformation of the flexible button head and at most of the flexible metal frame.

The printed circuit board 8 is preferably in the form of a rigid/flex circuit, and as a result the required rigidity is provided in the region of the tactile element (rigid region); a plurality of buttons can be connected to one another easily by means of the flexible region (not illustrated).

Advantages:
simple fitting, fastening of all component parts together with light source in one step;
light source where it is required in the button head.

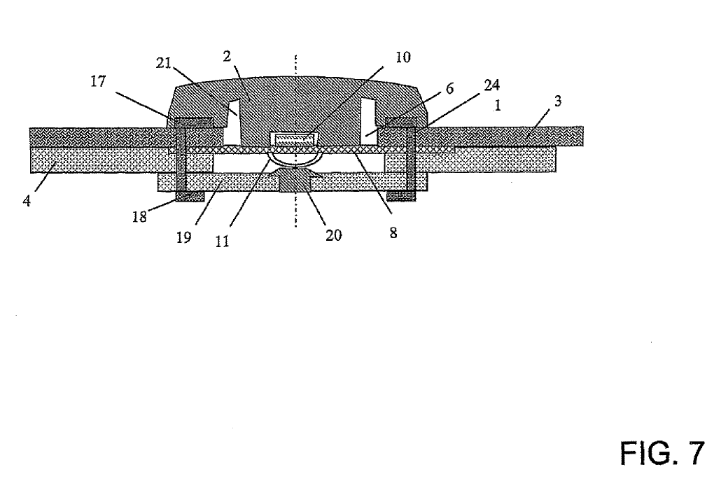

FIG. 7 illustrates a further exemplary embodiment, in this case a short-stroke button with an LED on a flex PCB.

In this variant, the metal dome 11 is arranged on the lower side and the light source 10 is arranged on the upper side of a double-sided flexible printed circuit board 8. The actuation of the metal dome 11 in this case takes place above the head via a silicone actuator 20. The latter is either inserted directly in the support 4 or is fitted on an additional support plate 19. A peripheral relief 21 can be provided in the flexible button head 2 in order to facilitate the stroke action.

Advantages:
light source where it is required in the button head;
simple fitting;
individual buttons can be connected to one another by a single flexible printed circuit board (not illustrated).

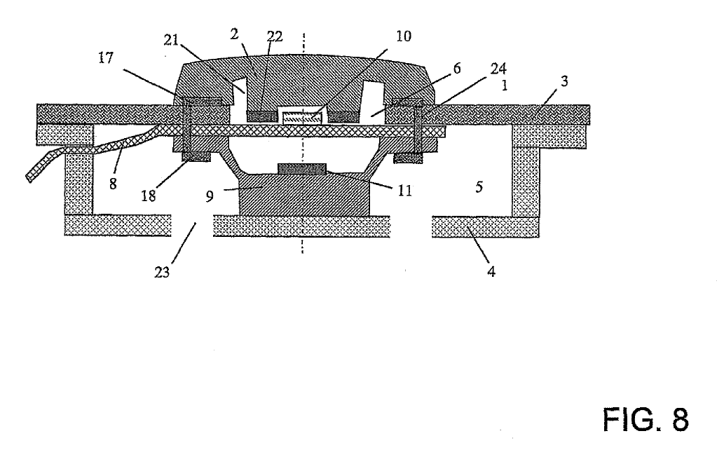

FIG. 8 illustrates a further exemplary embodiment in the form of a long-stroke button with an LED on a double-sided printed circuit board with a touch sensor.

Similar to the exemplary embodiment illustrated in FIG. 7, the printed circuit board 8 is again populated on both sides, if a light source (for example LED) is required and is either in the form of a rigid/flex PCB or purely in the form of a flex PCB in order to go along with the stroke. A cable is then passed out through the support.

The printed circuit board and the tactile element are inserted into the recess 5 through the cutout in the soft surface material 3. For fitting purposes, fitting holes 23 are provided in the support 4, through which the fastening lugs 18 can be bent back from the underside.

In addition to this there is also an additional sensor function 22, which on slight touching contact with the button head 2 via the peripheral relief 21 results in contact on the upper side of the printed circuit board. The element for the sensor can either be a conventional contact pill, but may also be another type of pressure sensor such as, for example, an FSR (force sensing resistor) or a capacitive sensor. This sensor function can also be incorporated in other variants. In other words, a sensor function (first switching plane) which is already activated given a low force and a switching function (second switching plane) which is only activated in the event of a greater force result.

Advantages:
light in button head;
space-saving;
additional sensor function allows novel applications such as the detection of the touch of a button.

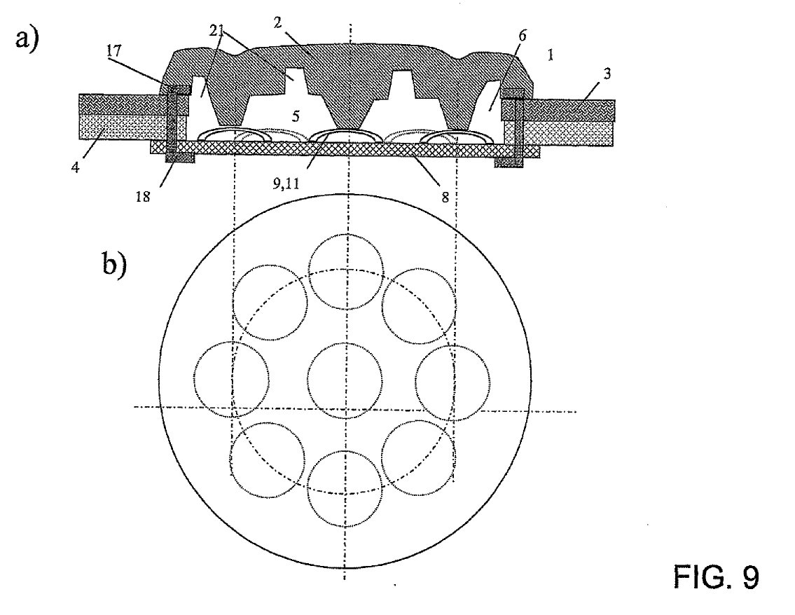

A further exemplary embodiment is illustrated in FIG. 9. In this case, the switch is in the form of a rotary knob or an incremented controller.

In other words, this refinement discloses the replacement of a conventional rotary knob with a switch which by itself is not capable of moving mechanically in rotary fashion and which is embedded in a soft surface material 3. The tactile incrementation of a rotary knob (for example for the volume control or temperature setting in a car) is replaced by the tactile elements (metal domes) being arranged very close to one another. Thus, this application can also be realized in a very simple and cost-effective manner (without mechanically rotating parts) directly in the surface material 3. Corresponding shaping of the button head can guide the finger through the “rotation”. A coating with a slidable varnish, for example sealplast, is recommended.

As a result of the successively individual switching of the metal domes 11 arranged in a circle, a correct rotary knob feel is produced (or similarly slides if arranged in a linear row, or else semicircular arrangements or any desired characteristics are possible). In the center, a further knob, for example in the form of a selection button, is fitted. Further functions such as LEDs or touch sensors can naturally also be introduced.

Advantages:
enormous cost saving in comparison with conventional rotary knobs;
space-saving, flat, integrated in the surface, same material as the rest of the buttons

### LIST OF REFERENCE SYMBOLS

1 Switch, button
2 Button head
3 Soft surface material
4 Support
5 Recess in 4
6 Cutout in 3
7 Base element
8 Printed circuit board/flex circuit/sensor
9 Tactile element
10 Light source
11 Contact element
12 Adhesive
13 Light-impervious layer
14 Layer on 2
15 Reliefs in 14
16 Button without 2
17 Metal frame
18 Fastening lugs, fastening element
19 Screw or other fastening component part
20 Silicone actuator
21 Peripheral relief in 2
22 Sensor function
23 Fitting holes in 4
24 Holes/slots in 3 for IS
25 Contact webs

1: A switch for at least partial embedding in or on a support, which is coated, at least in the region of the switch, on its surface with a surface material, the switch being arranged in a cutout of the surface material, the switch having a first region arranged substantially in the support, and a second region as a button head, which is provided for triggering a function, the button head being designed so as to cover the cutout in the surface material, at least in regions, and so as to be connected to it in a force-fitting and/or form-fitting manner.

2: The switch as claimed in claim 1, wherein the button heady covers the cutout peripherally and is adhesively bonded to flexible surface material peripherally, and wherein the button head is preferably made from a flexible material.

3: The switch as claimed in claim 1, wherein the button head has at least one fastening element, by means of which the button head is fastened in the surface region, which is covered by an underside of the button head, of the surface material to said surface material.

4: The switch as claimed in claim 3, wherein the fastening element is in the form of a lug, which engages in an opening in the surface material and is fastened in the latter either in a self-latching manner or by means of fastening by means of adhesive bonding and/or being bent back, preferably on the underside of the surface material, in a form-fitting and/or force-fitting manner.

5: The switch as claimed in claim 3, wherein the fastening element is fastened in a form-fitting manner in or on the button head.

6: The switch as claimed in claim 5, wherein a metal frame is arranged in and/or on the button head, at least one fastening element, which protrudes out of the button head or from said button head, being fastened and/or integrally formed on said metal frame.

7: The switch as claimed in claim 5, wherein a metal frame is arranged, at least in regions, peripherally in or on the button head and has a plurality of fastening elements in the form of lugs.

8: The switch as claimed in claim 3, wherein the fastening element and one or more possibly provided metal frames are made from a flexible and/or electrically conductive material, in particular from a metal.

9: The switch as claimed in claim 8, wherein the fastening element and the metal frame are designed to be integral and in particular are produced in a stamping deformation process.

10: The switch as claimed in claim 3, wherein at least one fastening element is used at least indirectly for making contact with a lighting element, which is arranged in the button head.

11: The switch as claimed in claim 10, wherein at least two fastening elements and a metal frame made from an electrically conductive material, in particular from a metal, are arranged, and wherein the metal frame comprises two electrically isolated segments, each segment having a fastening element, and in particular lighting element being connected with its two electrical terminals to these segments via webs or wires.

12: The switch as claimed in claim 3, wherein the at least one fastening element is in the form of a lug, which passes through openings in the surface material and in a printed circuit board and/or in the supports and/or in a fastening component part and is bent back on the side remote from the surface material.

13: The switch as claimed in claim 1, wherein the switch has a sensor function and a switch function, in this case in particular a printed circuit board, for example in the form of a flexible printed circuit board, being arranged, which printed circuit board provides, on one side, preferably the upper side, the functionality for the sensor function and, on the other side, preferably the underside, provides the switch function, with a further tactile element preferably being arranged on the underside for this purpose.

14: The switch as claimed in claim 1, wherein a large number of tactile elements is arranged beneath the button head, it being possible for these tactile elements to be arranged in a row and/or in a circle and/or a semicircle or in a combination thereof.

15: The switch as claimed in claim 1, wherein the first region has at least one tactile element, which produces a contact, with tactile feedback, on manipulation of the button head.

16: The switch as claimed in claim 1, wherein backlighting is provided.

17: The switch as claimed in claim 16, wherein the button head and tactile elements which are preferably arranged in the first region are made from a substantially transparent or translucent material, and wherein a light source is arranged in the first region.

18: The switch as claimed in claim 16, wherein regions on or in the button head are designed to be impervious to light so as to form backlit symbols.

19: The switch as claimed in claim 18, wherein a light-impervious coating is provided on the button head and has reliefs in the form of symbols or characters.

20: The switch as claimed in claim 1, wherein the flexible surface material is textile, leather, imitation leather, metal layer or a plastic layer or combinations thereof.

21: The switch as claimed in claim 1, wherein the support is a component part in the interior of a vehicle, in particular inner cladding, a steering wheel, a gearshift, a car seat or the like.

22: The switch as claimed in claim 1, wherein the button head has a round or angular convex surface possibly with round or angular concave sections or combinations thereof, which protrudes beyond the surface of the flexible surface material.

23: The switch as claimed in claim 1, wherein the first region is covered, at least in regions, preferably peripherally, by the cutout in the surface material.

24: The switch as claimed in claim 1, wherein a recess is provided in the support, a printed circuit board, a flex circuit or a sensor being provided on the bottom of said recess, a preferably transparent base element, which is either designed to have or to contain tactile elements, being provided on said printed circuit board, flex circuit or sensor, and a button head being arranged on said base element or on the tactile elements.

25: The switch as claimed in claim 1, wherein the switch has at least two different positions or control contacts, which can be manipulated via a single button head.

26: The switch as claimed in claim 1 as a single button, a rocker, a navigator, a two-stage switch, in particular in the interior of a vehicle preferably as a window opener, mirror adjuster, seat adjuster, or switches integrated in clad instrument panels for car radio/air conditioning/navigation/telephone.

27: A method for fitting a switch as claimed in claim 1, in a first step a support, for example a vehicle seat, being coated substantially over the entire area with a flexible surface material, in a second step the surface material being cut out to the desired size and under formation of a cutout in the region of recesses provided in the support, and in a third step the switch being inserted into the recess and the button head being adhesively bonded peripherally to the surface of the surface material in the edge region of the cutout.

28: The method as claimed in claim 27, wherein in the third step first the first region is inserted through the cutout into the recess and fixed therein, and then the button head is placed onto the first region and onto the surface material and fixed thereto.
